(19) United States
(12) Patent Application Publication
(10) Pub. No.: US 2022/0101215 A1
(43) Pub. Date: Mar. 31, 2022

(54) Model Maturity Level, Assessment Process and Tool

(71) Applicant: Branford John McAllister, Niceville, FL (US)

(72) Inventor: Branford John McAllister, Niceville, FL (US)

(21) Appl. No.: 16/948,093

(22) Filed: Sep. 2, 2020

(51) Int. Cl. G06Q 10/06

(52) U.S. Cl. CPC G06Q 10/067

(57) ABSTRACT

Program managers are responsible for assessing computer-based models used in their programs. No mechanism exists to evaluate models so current or potential users can assess their utility. The Model Maturity Level (MML) assessment process and tool is an objective method to assess the state of development of any model at a point in time. The process assigns an overall MML from 1 to 9—the lowest score among objective criteria based on attributes that users require in models. The assessment relies upon objective evidence (artifacts) showing that model attributes have been developed and proven through rigorous, industry-standard processes. The assessment includes a description of the model, the assessment rubric, and a summary of results. The MML concept and tool are based on previous work at NASA and DOE, plus other work in the scholarly literature. MMLs are analogous to the DoD's technology readiness levels (TRLs) for ease of translation.

### CROSS-REFERENCE TO RELATED APPLICATIONS

Not applicable

### STATEMENT OF FEDERALLY SPONSORED RESEARCH

This invention was made with United. States government support under the One Acquisition Solution for Integrated Services—Small Business (OASIS SB) contract awarded by the Air Force Life Cycle Management Center (AFLCMC) (Department of Defense [DoD]—United States Air Force [USAF]—Air Force Materiel Command [AFMC]), Wright Patterson AFB, OH. The government has certain rights in the invention.

### REFERENCE TO SEQUENCE LISTING

Not applicable

### BACKGROUND OF THE INVENTION

### Introduction

Program managers have a responsibility to monitor and assess the status of modeling instruments (MIs) used in support of their programs. This is increasingly more important today and in the future as complex programs are commonly considered “simulation-based acquisitions,” using models to perform the bulk of quantitative performance assessment of systems. To facilitate the effective use of credible models, program management and other stakeholders have frequently asked for a tool to assess the state and maturity of MIs, analogous to the DoD'sTechnology Readiness Levels (TRLs).

### Rationale

Model Maturity Levels (MMLs) provide an objective and universal means of assessing the state and maturity of all MIs. MMLs provide stakeholders a consistent set of terms, attributes, and metrics related to model maturity. MMLs provide a mechanism for tracking the development and maturity of MIs over time. Users have deeper insights into MIs intended for their use, and a single tool to enable them to assess the utility of a MI at any point in time. Users are better able to determine if a MI is suitable or if there is a need for a different kind of MI to meet their needs. Developers understand what attributes are considered important when assessing the maturity of their MIs. MMLs facilitate the articulation of clear expectations about what needs to be accomplished to increase the maturity of a MI. Finally, developers are incentivized to work toward higher levels of model maturity.

### Background

In the past, programs assessed the state of development (maturity) of MIs, but without a single, consistent, objective, and universal methodology. Maturity is not defined in the Department of Defense (DOD) modeling and simulation (M&S) glossary. The Department of Energy (DOE), which has worked extensively on concepts for model maturity, defines maturity as the state of development at a point in time toward a level of geometry, functionality, or fidelity (SAND2007-5948).

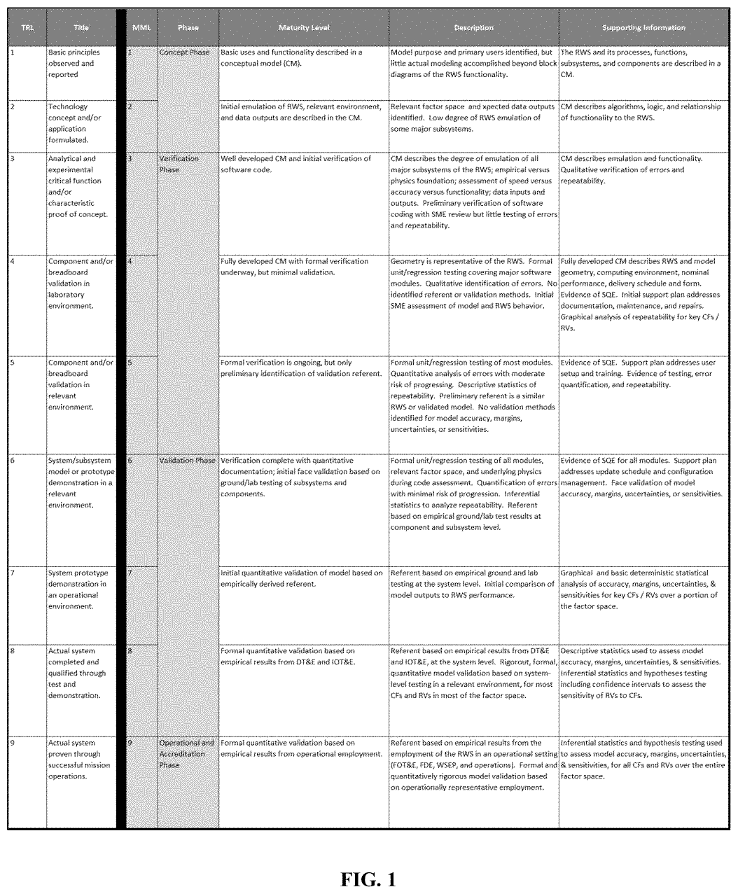

The MML concept and tools described here are based on previous work at NASA and DOE, plus other work in the scholarly literature. MMLs are patterned after the DoD's TRLs 1 through 9, for ease of translation among stakeholders who have a sense of what a “TRL-x” means (see the comparison in FIG. 1).

### BRIEF SUMMARY OF THE INVENTION

The MML assessment process and tool is a single, objective method and rubric, in the form of a table, to assess the state of development of any single MI, at a point in time, for the benefit of all M&S stakeholders—current or potential users of MIs, or those who might benefit from the MI or any analysis performed using the MI. MMLs are analogous to TRLs in the DoD, except they are focused on MIs (models, simulations, model-based facilities, etc.) and not technologies. The MMLs, described within a table, provide objective criteria for each level. The process involves assessing a MI at a point in time, against these criteria, and assessing the level achieved within each of the nine criteria. The overall MML for a MI is the lowest score among the nine criteria. The tool is a spreadsheet to record all the information required to assess the MI and a scoring table for each of the criteria.

### BRIEF DESCRIPTION OF THE VIEWS OF THE INVENTION

(Note: drawings submitted separately)

FIG. 1. TRLs versus MMLs

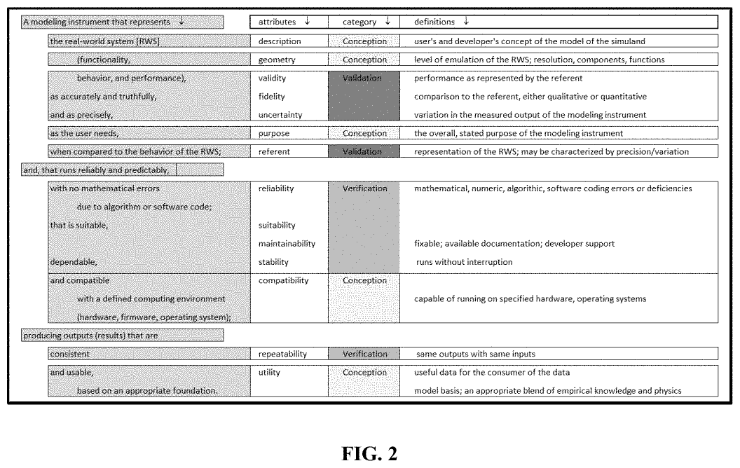

FIG. 2. Maturity attributes derived from what is needed from a modeling instrument

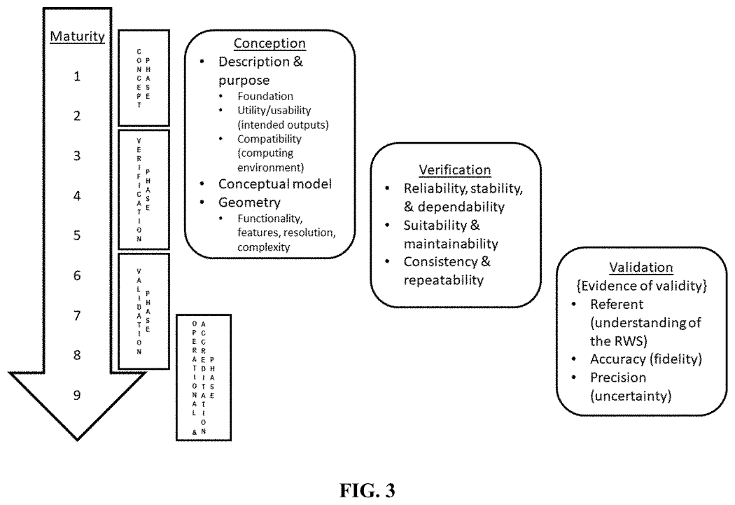

FIG. 3. A staggered approach to model maturity assessment

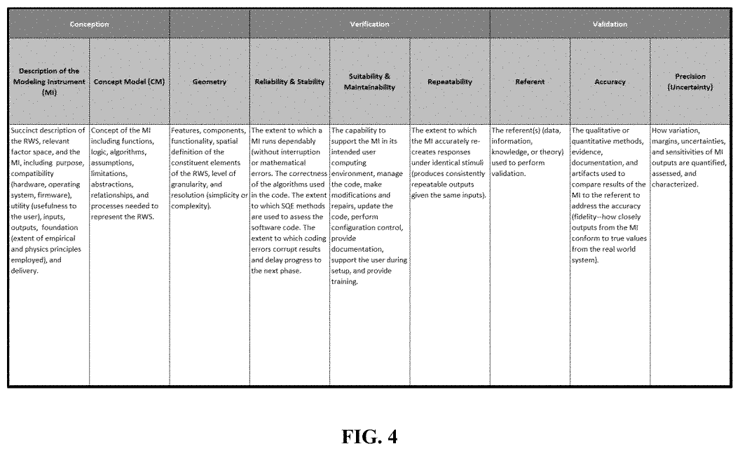

FIG. 4. The MML Tool: Table with columns representing the categories and attributes

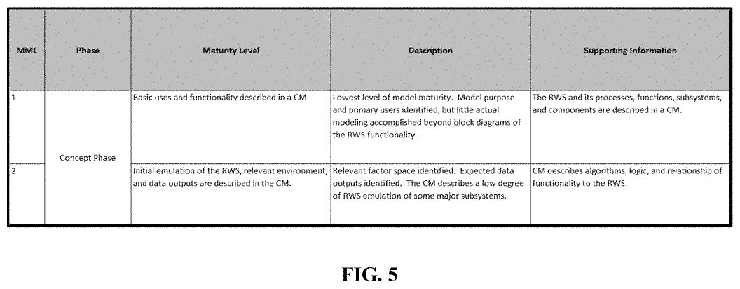

FIG. 5. MML table: Concept Phase

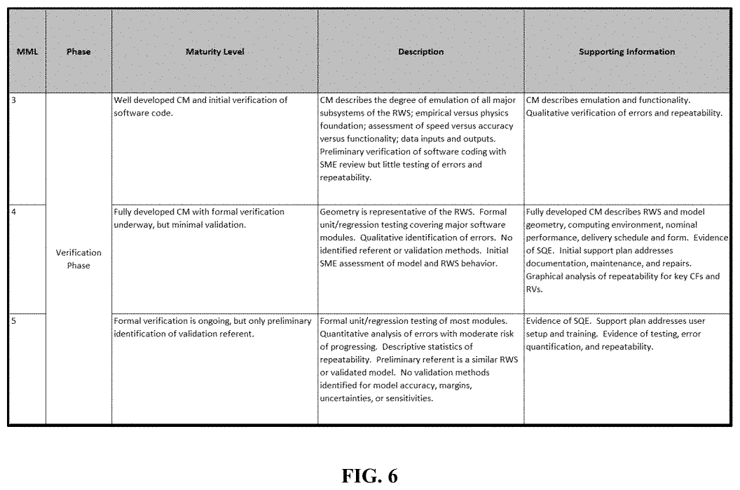

FIG. 6. MML table: Verification Phase

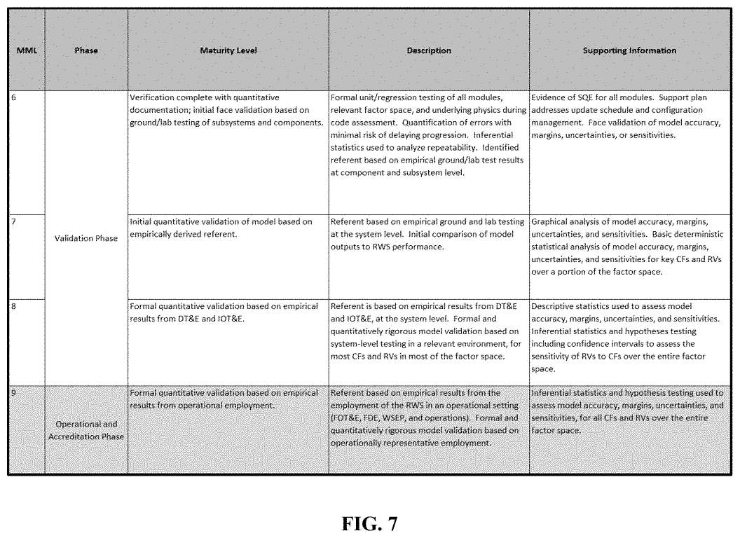

FIG. 7. MML table: Validation, Operational & Accreditation Phases

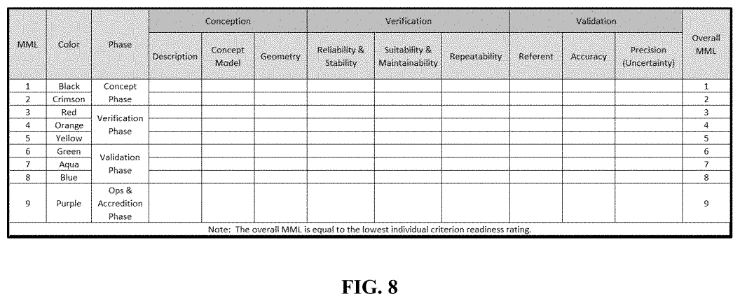

FIG. 8. MML assessment table

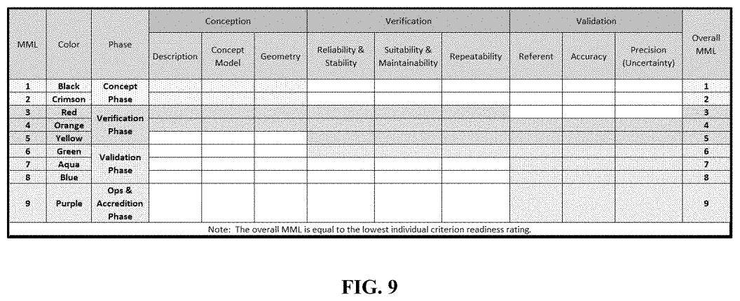

FIG. 9. MML assessment process in phases

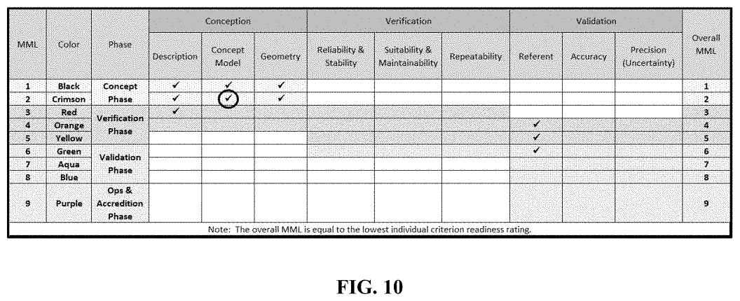

FIG. 10, MML assessment: Early example (MML=2)

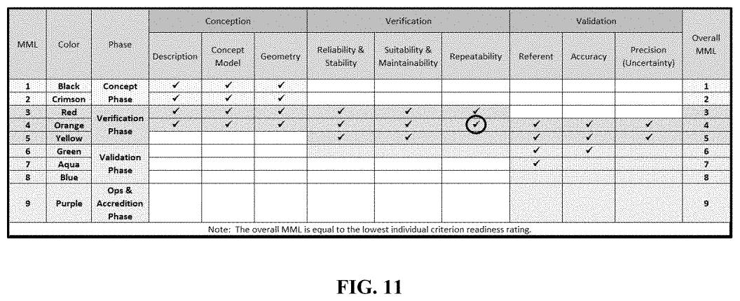

FIG. 11. MML assessment: Mid-term example (MML=4)

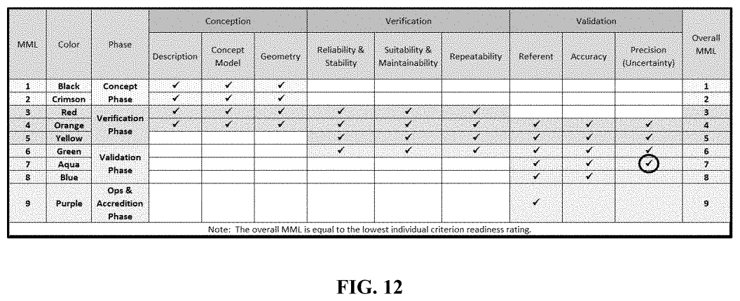

FIG. 12. MML assessment: Late-term example (MML=7)

For reference, here are the definitions for abbreviations used in the drawings (submitted separately): CF=control factor; CM=conceptual model; DT&E=developmental test & evaluation; FDE=force development evaluation; FOT&E=follow-on test & evaluation; IOT&E=initial operational test & evaluation; MI=modeling instrument; OT&E=operational test & evaluation; RV=response variable; RWS=real-world system; SME=subject matter expert or subject matter expertise; SQE=software quality engineering; WSEP=weapon system evaluation program.

### DETAILED DESCRIPTION OF THE INVENTION

### Model Maturity Defined

The MML is a description, indicator, and assessment of the general state of development of a MI. It reflects the extent to which accepted standards, methods, concepts, processes, and functionality have been incorporated in the MI. The MML reflects the state of ongoing development toward higher levels of geometry, functionality, reliability, and emulation; and evidence of fidelity (accuracy and precision).

MI maturity (whether at the system level, or at the subsystem/module level) is assessed using objective criteria within nine criteria, in three categories. The overall MML is a logical function of the nine individual criteria. The MML for a MI cannot be higher than the lowest rating among these nine individual attributes:
Conception
   Description
   Concept model
   Geometry
Verification
   Reliability & stability
   Suitability & maintainability
   Repeatability
Validation
   Referent
   Accuracy
   Precision

### Model Maturity Versus the User's Perspective

The MML process is a single maturity assessment for any MI at a snapshot in time. Any user, among many potential users, decides if the state of the instrument (based on its MML and associated artifacts) is suitable for their intended purpose. This concept is used instead of assessing the maturity of a single MI, many times, for each user's intended use; which would mean multiple maturity levels for the same instrument, at the same point in time, and at the same point in development. Because the maturity level is based on (a) objective criteria independent of any single user and (b) the demonstration of maturity based on artifacts, the rubric is used to identify the MML at a point in time and allows individual users to decide if the maturity is high enough for their needs.

This is not to say that the MI maturity is assessed without regard to an intended overall purpose, for which it was developed. Articulating the intended purpose is an essential first step in assessing model maturity.

The reason for this approach is that there may be many users of various Mk. Therefore, the key philosophical underpinning of the MML process is that whereas an MI has an overall purpose that led to its creation, the assessment of its maturity is focused more on the demonstration of evidence, through documentation and artifacts, of the rigorous process used to develop, verify, and validate the MI based on industry standards and best practices. The documentation required by the process and captured in the tool provides a description of the Ml, and evidence of the MI's maturity a clear and objective indication of its suitability for any user. Because no model is a perfect representation of the RWS, the geometry (emulation, resolution, complexity) and truthfulness (accuracy and precision) of the MI at any point of time may or may not be adequate for every individual user's needs.

### MMLs: Key Terms

The following terms and their definitions are key to an understanding of MMLs and the tool (reference list provided at the end of this specification):
Accuracy: Magnitude of the difference between MI outputs and the referent (M&SCO, NASA, SISO-REF-020).
Control factor (CF): Variable whose values are controlled during an experiment (independent variable).
Emulation: The degree to which the behavior of a real-world system (RWS) in a modeling instrument represents the functionality and phenomenology of the RWS using first principle physics (NASA, SISO-REF-002, SISO-REF-020).
Fidelity: The truthfulness (accuracy and precision) of a MI in representing the RWS (M&SCO, SISO-REF-020).
Foundation: The basis of a MI—a spectrum from empirically-based to physics-based.
Geometry: The entities of the RWS represented in the MI (SAND2007-5948, SISO-REF-020).
Modeling instrument (MI): Any model-related entity (model, simulation, device, facility, federation, application, tool, data, database).
Precision: Magnitude of the uncertainty or variation in MI outputs (SISO-REF-002, SISO-REF-020).
Real-world system (RWS): A real system operating in its real environment; may be a system, a subsystem, or a process.
Referent: Data or information about the RWS's characteristics, performance, or behavior against which the outputs of a MI can be compared (M&SCO, NASA, SISO-REF-002).
Response variable (RV): Output of a MI or experiment related to some measure of performance of interest (dependent variable).
Validation: The process and evidence of determining the degree to which a MI is an accurate and precise representation of the RWS based on a referent (M&SCO).
Verification: The process and evidence of determining the reliability, stability, suitability, maintainability, and repeatability of the MI (M&SCO).

### MML Tool

The MML tool is a single, objective rubric (captured in a spreadsheet table) to assess the state of development of a single MI at a point in time, for the benefit of all M&S stakeholders. MMLs are analogous to TRLs, except they are focused on MIs (models, simulations, model-based facilities, etc.) and not technologies.

FIG. 2 illustrates what attributes are needed from a MI, and that expression of need is translated into MML criteria. To summarize the baseline need for an MI (column 1 of FIG. 2):
a MI that represents the RWS (in functionality, behavior, and performance); as accurately, truthfully, and precisely as the user needs; when compared to the behavior of the RWS; and that runs reliably and predictably, with no mathematical errors due to algorithm or software code; that is suitable, dependable, and compatible with a defined computing environment (hardware, firmware, operating system); producing outputs (results) that are consistent and usable, based on an appropriate foundation (empirical evidence and physics).

The MML process is predicated on this understanding of what is expected from an MI which, more specifically, establishes the attributes that must be considered to evaluate its maturity (column 2 of FIG. 2). These attributes are organized in three categories, as shown in column 3 (conception, verification, and validation) and defined in column 4.

The MIL tool is a spreadsheet, composed of three main parts:
A description of the MI and the RCVS it represents (overall purpose, type of use and users, etc.).
The MML rubric—the assessment tool (a table of attributes and criteria).
A summary of the assessment of the MI at a point in time, which addresses the attributes.

### Purpose Versus Intended Use

Regarding model maturity, there is a need to distinguish between two important, related, but different concepts:
An overall, macro, general purpose of a MI (stated up front in the description of the MI; the original basis of its development).
A specific user's intended use, which may be the same as the MI's purpose, or modified or adapted by the user.

There may be many users of a particular MI. Users have specific requirements which are fulfilled with a variety of MIs (hence the detailed description up front of every assessment). Therefore, it is not feasible, desirable, nor possible to assess the maturity of a MI individually based on every user's specific and particular intended use (as with TRLs which are not assessed based on every possible use of the technology)—in other words, to produce multiple maturity assessments for the same MI at a single point in time for all potential users. Instead, model maturity is assessed independently of each user's intended use; it is assessed against the general purpose of the MI using an absolute and objective set of measures of maturity (progress)—allowing each user to decide if the MI is suitable for their use.

While the intent is to produce kits useful to all users (stakeholders), any assessment of whether the MI's utility and maturity are satisfactory is a decision for individual users. When a MI does not provide what the user needs (either its utility, complexity, or accuracy; or its current state of maturity), then a choice must be made: (a) determine what can be done to modify or improve the MI incrementally to achieve more utility, (b) articulate a requirement to develop a different MI or a derivative or variant of the MI, or (c) live with the MI in its present state of maturity and determine how it can serve the user's need in spite of its deficiencies.

### The Concepts of Fidelity, Foundation, and Emulation

There are subtle distinctions in the published definitions, which necessitates a restatement of the definitions used in the MML process and tool. In particular, there is frequent misuse of the term, fidelity. Fidelity is the state of truthfulness of a MI; how closely the MI replicates the performance or behavior of the RWS; the degree to which a MI reproduces the state and behavior of a RWS; a measure of the realism of a MI. Fidelity of the MI is described with respect to the measures used in assessing performance of the RWS (M&SCO, SISO-REF-020).

In contrast to fidelity, and what many often mean when they use the term fidelity, are the concepts of foundation (the degree to which the MI is based on physics and physics principles) and emulation (the degree to which the MI represents the functionality, geometry, and phenomenology of the RWS). Many assume the more physics employed by the MI, the higher its accuracy (fidelity)—and, therefore, they use the terms interchangeably. In fact, some empirical models are more accurate than some physics models, over a range of conditions; especially where theory is incomplete; the RWS and are in an early state of development; or the phenomenon is complex, noisy, and poorly understood.

An empirical model (even if more accurate and precise) may provide less understanding of the underlying phenomenology than a physics-based model. And, some investigations require insights into the phenomenology and functionality of the RWS (sometimes at very minute levels of detail—component or subcomponent level)—those studies are accomplished using a highly sophisticated, physics-based model (referred to as a highly emulative model). However, in other instances, it may be possible to acquire an acceptable understanding of functionality and phenomenology of the RWS, efficiently and precisely, using a model at a lower level of emulation—perhaps an empirical model with higher speed. The empirical model may indicate where to look to investigate poorly understood phenomenology. Some users and some analyses do not require the level of detail in a highly emulative (physics model); and may prefer speed over resolution. This is an illustration of how the MML process provides users an understanding of the MI's capabilities and maturity.

The accuracy (fidelity) and precision (certainty) of a MI are not necessarily indicators of its maturity, and rarely the sole indicators of its state of development (maturity). All MIs are inaccurate and imprecise and there is rarely a universal and specific requirement for accuracy and precision. Instead, the accuracy and precision of a MI are components of and considerations for the MI's utility by any individual user. The maturity level of the MI should include an assessment of the existing accuracy and precision. But, more appropriately, the maturity level of the MI reflects the evidence of that accuracy and precision, the developmental process that led to its attributes, the process of a rigorous verification and validation (V&V) process, and the outcome of that V&V process—part of which is a calculation of the MI's current accuracy and precision.

It is essential to understand that there is a tradeoff between foundation, sophistication, emulation on the one hand; and, on the other hand, speed. The intent of the model maturity process and tool is to describe a MI's foundation and nominal performance, and allow the specific user to decide if the MI is suitable or not (including whether is it accurate and precise enough, among all of its attributes); and, if not, then to articulate the requirement for a different MI for their use.

### Validation: The Essential Task

Validity is the degree to which the MI is a sufficiently accurate and precise representation of the RWS based on the MI's purpose. Validation and model maturity assessment go hand in hand (SISO-REF-020, Law & Kelton).

All MIs are imperfect—inaccurate and imprecise to some degree. Their outputs are almost always stochastic (run-to-run variability). The required degree of accuracy and precision is in the eye of the user. Model developers strive to understand the accuracy and precision of their MIs, and certainly to deliver the best performance possible; but, they do not necessarily specify the accuracy and precision of their MIs. The MI's performance information is provided to all stakeholders as part of the maturity assessment, along the documentation of the process used and the artifacts that result from the V&V effort. The questions for the individual user are, (a) how much accuracy and precision are needed? and, (b) are the accuracy and precision of an MI adequate for the user's intended use?

The questions that must be addressed when validating an MI, and assessing MI maturity in conjunction with validation, are the following:
What objective evidence in the form of artifacts, analysis, and metrics (agreed upon by the accreditation authority) is available that demonstrates the accuracy and precision of the MI?
What referent was used to determine the MI's accuracy and precision?
What processes were used to validate the MI? (and, how rigorous were they?) Maturity is NOT strictly related to the accuracy and precision of the MI, but the rigor and completeness of the process of ascertaining validity (the V&V effort), and the quality and credibility of the evidence of its accuracy and precision.

### Issues with MMLs

The MML tool is not meant to be a measure of developer (contractor) performance. It is not intended to be a tool to decide if the developer (contractor) should progress past a milestone. And, it is not a tool to measure accuracy, precision, readiness, quality, foundation, capability, or utility. Instead, the tool facilitates the process of maturing a MI, provides a rubric for assessing progress (and maturity) throughout the MI development process, and describes the artifacts required for demonstrating that the MI has reached various levels of maturation. The attributes of the MI (accuracy, precision, and so on) are demonstrated through the artifacts that are required to reach higher levels of maturity. The rubric that comprises the MML tool is focused on the documentation of a rigorous process of development, which produces a clear, objective, and thorough understanding of the state of the MI so that stakeholders understand that state of development and the potential users understand how beneficial the MI will be for their intended use,

To mitigate the downsides, MMLs must be used appropriately, based on a recognition that model maturity will be assessed one way or another; but without MMLs that assessment would be performed informally and without a consistent approach. The tool must be explained to stakeholders, refined by a continuous improvement process, and used by program management with discipline and as an objective and non-punitive assessment of model maturity.

### A Staggered Approach to Model Maturity

The MML assessment process relies on a staggered approach to assessing model maturity, that recognizes the nine distinct attributes or criteria within three overlapping categories (conception, verification, validation). The categories correspond roughly to four phases in the maturity development process. These are depicted in FIG. 3.

The MML's nine levels covering four phases represent the maturity cycle of a MI (these are the rows of the MML table). The three categories of model maturity attributes (conception, verification, and validation) and their corresponding phases are illustrated in FIG. 3. The categories are staggered and somewhat overlapping to reflect the normal model development cycle. The concept recognizes that until the MI is conceived and articulated in the form of a conceptual model that addresses the composition of the MI (including functionality, foundation, complexity, and resolution), it is pointless to engage in serious verification and validation. Similarly, while validation can begin while some verification is being completed, rigorous validation is not possible until there is evidence that the N/11: is reliable, stable, suitable, maintainable, and repeatable. Hence the staggered approach to achieving higher and higher levels of model maturity.

### The MML Table

The MML tool is a spreadsheet, composed of three main parts: description, the MML table, and a summary. The MML table (spreadsheet) is composed of columns representing the three categories and nine attributes by which MI maturity is assessed. The rows reflect increasing levels of maturity, and are analogous to the DoD's TRL levels.

The definition of each attribute (column) is depicted in FIG. 4. The MML tool provides specific criteria for each cell in the table, These are objective criteria that must be met for the MI to achieve a specific model maturity level (1 through 9), for any maturity attribute (represented by columns in the table).

The tool has nine MML levels covering four phases that represent the maturity cycle of a MI. These phases correspond to the three staggered, yet overlapping tasks (conception, verification, and validation) plus a final phase called, Operational and Accreditation Phase. These phases, with descriptions and supporting evidence, are illustrated in FIGS. 5 through 7.

The MML tool provides specific criteria for any cell in the table. In other words, there are objective criteria that must be met for the MI to achieve a maturity level (1 through 9), for any maturity attribute (represented by columns in the table).

FIGS. 5 through 7 provide the criteria to reach each level of maturity. For example, to reach a MML of 2, and complete the conception phase of development, the compatibility of the MI must be described in the first part of the process and tool (i.e., the computing environment, minimum acceptable hardware, operations system, and firmware). Nominal performance (speed, efficiency) is described given minimally acceptable or expected computing environment, The delivery schedule and the form of the deliverable are clearly articulated.

Then, the criteria for MMLs 1 and 2 must be met: The conceptual model (CM) must adequately articulate the algorithms, logic, relationships, assumptions, limitations, and data inputs/outputs for all physical processes, functions, subsystems, components representing the RWS. The GM has been validated by SME judgment as adequate for (a) meeting the purpose of the MI and (b) supporting development of the MI. Geometric representation is consistent with the RWS—a high degree of emulation of RWS functionality is evident in the MI. All the major/critical RWS subsystems and components are modeled. Little to no defeaturing and/or simplification is evident at the subsystem level or component level. Model geometry relies on the CM, SME judgment, peer-review, and independent review by the user or reviewers external to the developer's organization.

To reach a MML-5, and complete the verification phase, evidence is provided that all modules of the code were developed, managed, and assessed using software quality engineering (SQE) practices. Formal software unit/regression testing based on documented analytical benchmarks has been performed by the developer, with independent review by SMEs external to the developer's organization. Coverage of all software modules, relevant factor space, and underlying physics have been demonstrated during code assessment. Formal quantitative methods have been used to identify and characterize software coding/numerical errors and the impact on output accuracy. The impact of errors on the accuracy of outputs is not likely to result in delayed progression, A plan exists that demonstrates the capability to support the MI and its software code in its intended (expected) user and computing environment, provide documentation, and make timely modifications and repairs. The plan provides support for the user, including setup and training; explains the process and schedule for updates; and provides configuration management and control. Repeatability of MI outputs using the same inputs has been demonstrated by a comparison using inferential statistics, for all control factors and response variables, over the entire factor space.

A MML of 8, and the completion of validation, requires documented empirical results from tests of the RWS at the system level in a relevant setting or environment; comparison using descriptive statistics between MI outputs and the referent; statistical analysis to calculate uncertainties (confidence intervals), sensitivities of response variables to control factors, and ranges over which specified or minimally acceptable accuracies can be guaranteed for the MI. Analysis has been completed for most control factors and response variables, over most of the overall factor space.

Finally, to attain an MML-9 requires documented empirical results from employment of the RWS in the user's operational environment, setting, and conditions. This requires comparison using inferential statistics (parametric and non-parametric tests) between MI outputs and the referent. Formal, rigorous, quantitative/statistical analysis has been performed to calculate uncertainties (confidence intervals), sensitivities of response variables to control factors, and ranges over which specified or minimally acceptable accuracies can be guaranteed for the modeling instrument; for all control factors and response variables, over the entire factor space.

### MML Assessment

FIG. 8 illustrates the entire MML assessment tool, without the specific narrative criteria in each cell of the table. Model maturity evolves over the development of a MI through staggered phases, illustrated in FIG. 9.

FIGS. 10 through 12 illustrate a notional example of how the maturity of a MI might progress through its development. The development and evolution of maturity are illustrated in three examples: an early assessment (MML=2); a mid-term assessment (MML=4); and, a late assessment (MML=7). Note once again that the MMI, for a MI cannot be higher than the lowest rating among the nine attributes.

### Summary of the MML Tool

Program managers and their MS&A enterprises are responsible for monitoring and assessing the status of MIs used in support of their programs. Though model maturity has been assessed in the past, it was informal at best, without a tool to assess the state and maturity of MIs used in a program analogous to the DoD's TRLs for technology. The MML process represents an objective means of assessing the state and maturity of all MIs with a consistent set of terms, attributes, and metrics. The MML tool provides an appraisal and deep insights into MIs. Stakeholders (developers, users, managers) are provided a single appraisal that will enable them to decide the utility and suitability of a MI at any point in time. Developers will understand what attributes are considered important when assessing the maturity of their Mk. The MML process leads to better MIs and a better understanding of their state of development.

### REFERENCES

Department of Defense, Modeling & Simulation Coordination Office (M&SCO). (2020). M&S glossary. Retrieved from http://www.msco.mil/MSGlossary.html.
Law, A. M. & Kelton, W. D. (2000). Simulation modeling and analysis. Boston: McGraw-Hill. National Aeronautics and Space Administration (NASA). (2008). Standard for models and simulations (NASA-STD-7009).
Sandia National Laboratories (SNL). (2007). Predictive capability maturity model for computational modeling and simulation (SNL Report SAND2007-5948).
Simulation Interoperability Standards Organization (SISO), Implementation Study Group. (1999). Report from the fidelity implementation study group (SISO-REF-002). Retrieved from https://www.sisostds.org.
Simulation Interoperability Standards Organization (SISO), Product Development Group. (2009). Guide for: DIS plain and simple (SISO-REF-020). Retrieved from https://www.sisostds.org.

1. The claim in this specification is in two parts: the process and the tool for evaluating the maturity level of a modeling instrument (the model maturity level). The process is an assessment of a modeling instrument using objective criteria based on the attributes that users require in models. The assessment relies upon objective documentary evidence (artifacts) showing that certain model attributes have been developed, attained, and proven through rigorous, industry standard processes. The assessment is captured in a tool composed of a description of the modeling instrument, a spreadsheet table (rubric) for recording the attainment of the objective criteria, and a summary of results. The overall MML is a score, no higher than the lowest score on nine individual criteria. To date, no mechanism has been developed in the government or in industry that can assess, objectively, the maturity of computer-based modeling instruments so that individual users are able to assess the utility of those modeling instruments for their individual uses.
